(19) United States
(12) Patent Application Publication
(10) Pub. No.: US 2011/0241769 A1
(43) Pub. Date: Oct. 6, 2011

(54) INTERNAL VOLTAGE GENERATOR OF SEMICONDUCTOR INTEGRATED CIRCUIT

(76) Inventor: Ho-Don Jung, Gyeonggi-do (KR)

(21) Appl. No.: 12/833,738

(22) Filed: Jul. 9, 2010

(30) Foreign Application Priority Data
Mar. 31, 2010 (KR) 10-2010-0029587

(51) Int. Cl. G05F 1/10

(52) U.S. Cl. 327/543; 327/538

(57) ABSTRACT

An internal voltage generator of a semiconductor integrated circuit includes a comparison unit configured to compare a reference voltage with a feedback voltage, a driving unit configured to drive an internal voltage terminal in response to an output signal of the comparison unit, and a feedback unit configured to divide a voltage of the internal voltage terminal according to a division ratio adjustable in response to a control signal and output a division voltage as the feedback voltage.

### CROSS-REFERENCE TO RELATED APPLICATIONS

The present application claims priority of Korean Patent Application No. 10-2010-0029587, filed on Mar. 31, 2010, which is incorporated herein by reference in its entirety.

### BACKGROUND OF THE INVENTION

Exemplary embodiments of the present invention relate to semiconductor design technology, and more particularly, to an internal voltage generator of a semiconductor integrated circuit.

As semiconductor devices are developed to increase operation speed and reduce power consumption using ultra-fine process technology, operating voltages are also further lowered. Most semiconductor devices include an internal voltage generator configured to generate an internal voltage by using an external power supply voltage, so that internal circuits of the semiconductor devices are supplied with appropriate voltages. In designing such an internal voltage generator, a main issue is to constantly maintain an internal voltage at a desired level.

One representative internal voltage is a core voltage (VCORE), which is used in a core region where memory cells are provided. In the following description, a core voltage generator, which generates a core voltage (VCORE), and a write driver, which uses the core voltage generated by the core voltage generator as a source voltage, are considered.

FIG. 1 is a block diagram illustrating a partial configuration of a semiconductor integrated circuit.

Referring to FIG. 1, the semiconductor integrated circuit includes a core voltage generator 100 and a plurality of write drivers 200. The core voltage generator 100 is configured to receive a reference voltage VREFC and generate a core voltage VCORE. The write drivers 200 are configured to use the core voltage VCORE generated by the core voltage generator 100 as a source voltage in response to a write enable signal BWEN.

FIG. 2 is a circuit diagram illustrating the core voltage generator 100 of FIG. 1.

Referring to FIG. 2, the core voltage generator 100 includes a comparison unit 110, a driving unit 120, and a division unit 130. Specifically, the comparison unit 110 is configured to compare the reference voltage VREFC with a fed-back half core voltage VHALFCORE. The driving unit 120 is configured to drive a core voltage (VCORE) terminal to a power supply voltage VDD in response to an output signal of the comparison unit 110. The division unit 130 is provided between the core voltage terminal and a ground voltage (VSS) terminal, and configured to divide the core voltage VCORE at a preset division ratio and feed the division voltage, that is, a half core voltage VHALFCORE, back to the comparison unit 110.

The comparison unit 110 is implemented with a current mirror differential amplifier.

The driving unit 120 includes a PMOS transistor having a source coupled to a power supply voltage (VDD) terminal, a drain coupled to the core voltage (VCORE) terminal, and a gate receiving the output signal of the comparison unit 110.

The division unit 130 includes division diodes D1 and D2 coupled in series between the core voltage (VCORE) terminal and the ground voltage (VSS) terminal and configured to output the half core voltage VHALFCORE. The division unit 130 may also be implemented with resistors, instead of the diodes D1 and D2. Since the division elements of the division unit 130 are configured so that they have the same voltage difference at both terminals thereof, the division unit 130 outputs the half core voltage VHALFCORE corresponding to the medium voltage level between the core voltage VCORE and the ground voltage VSS.

FIG. 3 is a circuit diagram illustrating the write driver 200 of FIG. 1.

Referring to FIG. 3, the write driver 200 includes a latch unit 210 and an output driving unit 220. Specifically, the latch unit 210 is configured to latch data loaded on global input/output lines GIO and GIOB. The output driving unit 220 is configured to output the data latched in the latch unit 210 to local input/output lines LIO and LIOB. When a write enable signal BWENB is activated, the latch section 210 determines the voltage levels of driving control signals LAT and LATB and DRV and DRVB in response to the data signals loaded on the global input/output lines GIO and GIOB. The output driving unit 220 pulls up the local input/output lines LIO and LIOB to the core voltage VCORE and pulls down the local input/output lines LIO and LIOB to the ground voltage VSS in response to the driving control signals LAT and LATB and DRV and DRVB. The output driving unit 220 precharges the local input/output lines LIO and LIOB to the half core voltage VBLP in response to a precharge signal LIOPCGB. The write enable signal BWENB and the precharge signal LIOPCGB maintain a substantially similar timing. When the write enable signal BWENB is activated, the precharge signal LIOPCGB is deactivated. On the other hand, when the write enable signal BWENB is deactivated, the precharge signal LIOPCGB is activated.

The operation of the semiconductor integrated circuit configured as above will be described below.

The core voltage generator 100 down-converts the external power supply voltage VDD and generates the constant core voltage VCORE. The write driver 200 precharges the local input/output lines LIO and LIOB to the half core voltage VBLP. In this manner, when the local input/output lines LIO and LIOB are enabled or precharged, the local input/output lines LIO and LIOB are rapidly driven to the core voltage VCORE or the ground voltage VSS. Thus, use of the write driver 200 may be advantageous in terms of current consumption.

When the write enable signal BWENB is activated, the write driver 200 pulls up or pulls down the local input/output lines LIO and LIOB in response to first and second data signals applied to the global input/output lines GIO and GIOB. Accordingly, the data is stored in a corresponding memory cell.

Meanwhile, during the write operation of the write driver 200, the consumption of the core voltage VCORE increases and the voltage level of the core voltage (VCORE) terminal of the core voltage generator 100 is lowered. Therefore, the core voltage generator 100 performs the following operation in order to constantly maintain the core voltage (VCORE) terminal at the core voltage VCORE. First, the comparison section 110 detects that the half core voltage VHALFCORE fed back from the division unit 130 is lower than the reference voltage VREFC. The driving unit 120 drives the core voltage (VCORE) terminal to the power supply voltage VDD in response to the output signal of the comparison unit 110. For example, where the output of the comparison unit 110 is a logic low level, the driving unit 120 may drive the core voltage (VCORE) terminal to the power supply voltage VDD. In this case, the voltage level of the core voltage VCORE rises and the half core voltage VHALFCORE outputted from the division unit 130 also rises. As a result of the comparison unit 110, when the half core voltage VHALFCORE is equal to the reference voltage VREFC, the driving unit 120 is disabled in response to the output signal of the comparison unit 110. Through these operations, the voltage level of the core voltage (VCORE) terminal is constantly maintained.

However, the core voltage generator of the conventional semiconductor integrated circuit has the following limitations.

The operating current used when the write driver 200 operates and the resistance of the ground voltage (VSS) line itself may cause a variation in the voltage level of the ground voltage VSS. In other words, as the operating current of the write driver 200 increases or the distance between the core voltage generator 100 and the ground voltage (VSS) pad becomes longer, the voltage level of the ground voltage VSS rises. In this case, the voltage level of the core voltage (VCORE) terminal of the core voltage generator 100 is also affected. Specifically, the division unit 130 divides the voltage applied between the core voltage (VCORE) terminal and the ground voltage (VSS) terminal at a preset division ratio, and outputs the division voltage as the half core voltage VCORE. At this time, when the voltage level of the ground voltage VSS rises, the voltage level of the half core voltage VHALFCORE outputted from the division unit 130 also rises accordingly. Thus, the output signal of the comparison unit 110 is affected, which will also affect the operation of the driving unit 120. Consequently, the voltage level of the core voltage (VCORE) terminal is maintained at a voltage level different from a normal voltage level.

FIG. 4A is an exemplary view illustrating the voltage levels of the core voltage VCORE and the ground voltage VSS during the write operation in a low frequency environment, and FIG. 4B is an exemplary view illustrating the voltage levels of the core voltage VCORE and the ground voltage VSS during the write operation in a high frequency environment.

As can be seen from FIGS. 4A and 4B, the voltage level of the core voltage VCORE is lowered by as much as the increase in the voltage level of the ground voltage VSS. That is, in the low frequency environment, the voltage level of the ground voltage VSS rises by 0.03V and thus the voltage level of the core voltage VCORE is targeted to a lower level, that is, 1.27 V. Meanwhile, in the high frequency environment, the voltage level of the ground voltage VSS rises by 0.07 V and thus the voltage level of the core voltage VCORE is targeted to a lower level, that is, 1.23 V. In this case, the voltage level of the ground voltage VSS further rises in the high frequency environment than in the low frequency environment. Thus, the voltage level of the core voltage VCORE is maintained at a lower level in the high frequency environment than in the low frequency environment. When the operating speed becomes fast like in the high frequency environment, the operating current increases so that the voltage level of the ground voltage VSS further rises.

As the voltage level of the ground voltage VSS rises, malfunction may occur during the write operation when the core voltage VCORE is maintained at a voltage level that is less than the upper voltage Vih which is a reference voltage level recognized as a “logic high” level in the semiconductor integrated circuit.

### SUMMARY OF THE INVENTION

Exemplary embodiments of the present invention are directed to an internal voltage generator of a semiconductor integrated circuit, which substantially maintains a voltage level of a core voltage (VCORE) terminal at a certain target level by compensating a voltage level of a ground voltage (VSS) which rises during a write operation.

In accordance with an exemplary embodiment of the present invention, an internal voltage generator of a semiconductor integrated circuit includes: a comparison unit configured to compare a reference voltage with a feedback voltage; a driving unit configured to drive an internal voltage terminal in response to an output signal of the comparison unit; and a feedback unit configured to divide a voltage of the internal voltage terminal according to a division ratio adjustable in response to a control signal and output a division voltage as the feedback voltage.

### BRIEF DESCRIPTION OF THE DRAWINGS

FIG. 1 is a block diagram illustrating a partial configuration of a semiconductor integrated circuit.

FIG. 2 is a circuit diagram illustrating a core voltage generator of FIG. 1.

FIG. 3 is a circuit diagram illustrating a write driver of FIG. 1.

FIGS. 4A and 4B are timing diagrams illustrating characteristics of a ground voltage and a core voltage which are varied during a write operation.

FIG. 5 is a block diagram illustrating a core voltage generator of a semiconductor integrated circuit in accordance with an exemplary embodiment of the present invention.

FIG. 6 is a circuit diagram illustrating the core voltage generator of FIG. 5.

FIG. 7 is a timing diagram illustrating a ground voltage and a core voltage during a write operation.

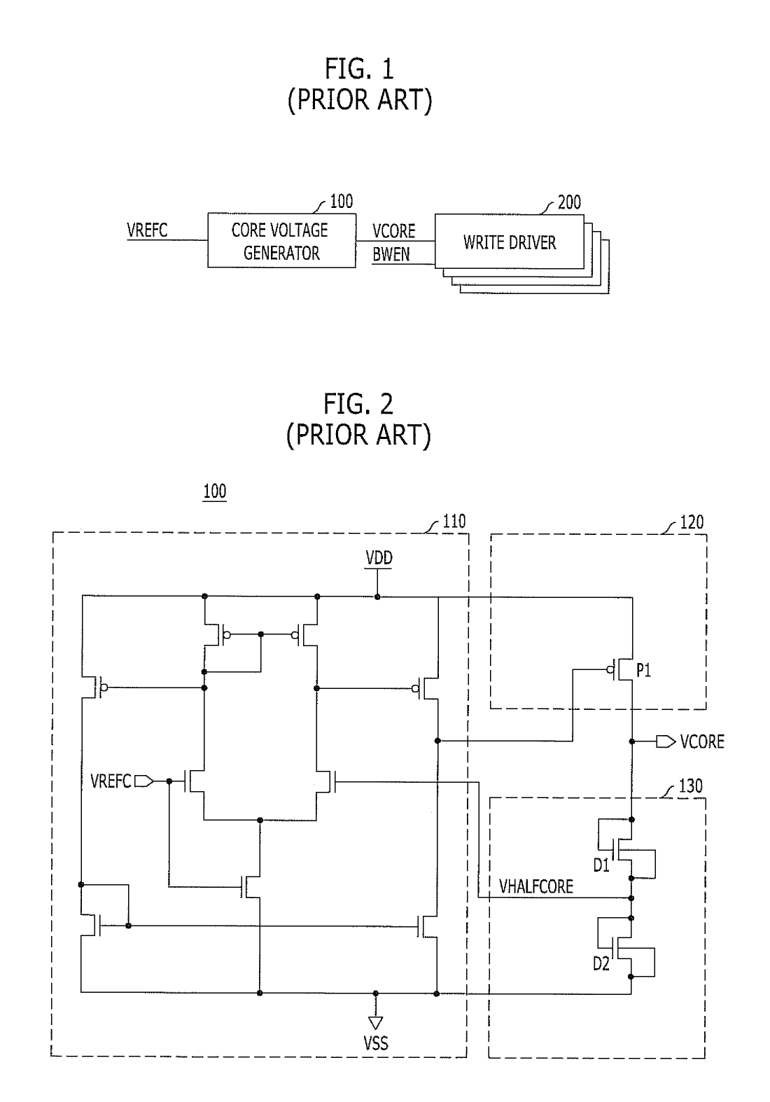

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

In the following description, a core voltage generator for generating a core voltage (VCORE) is considered in an exemplary embodiment of the present invention. Also, a sourcing of a core voltage (VCORE) during a write operation of a semiconductor integrated circuit is considered in an exemplary embodiment of the present invention.

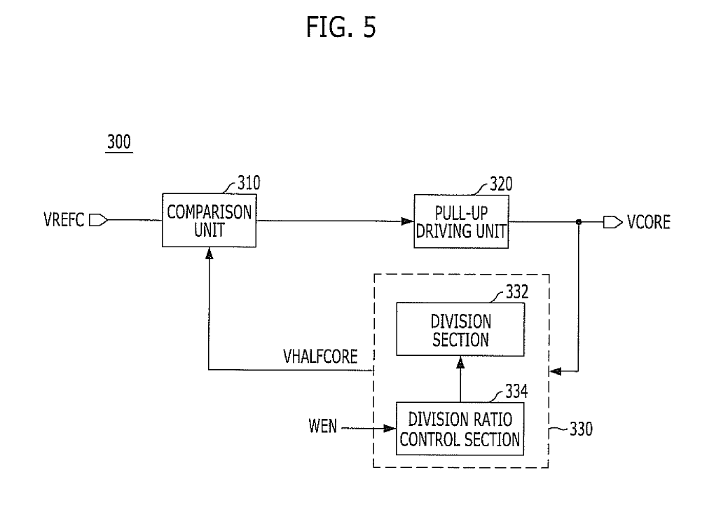

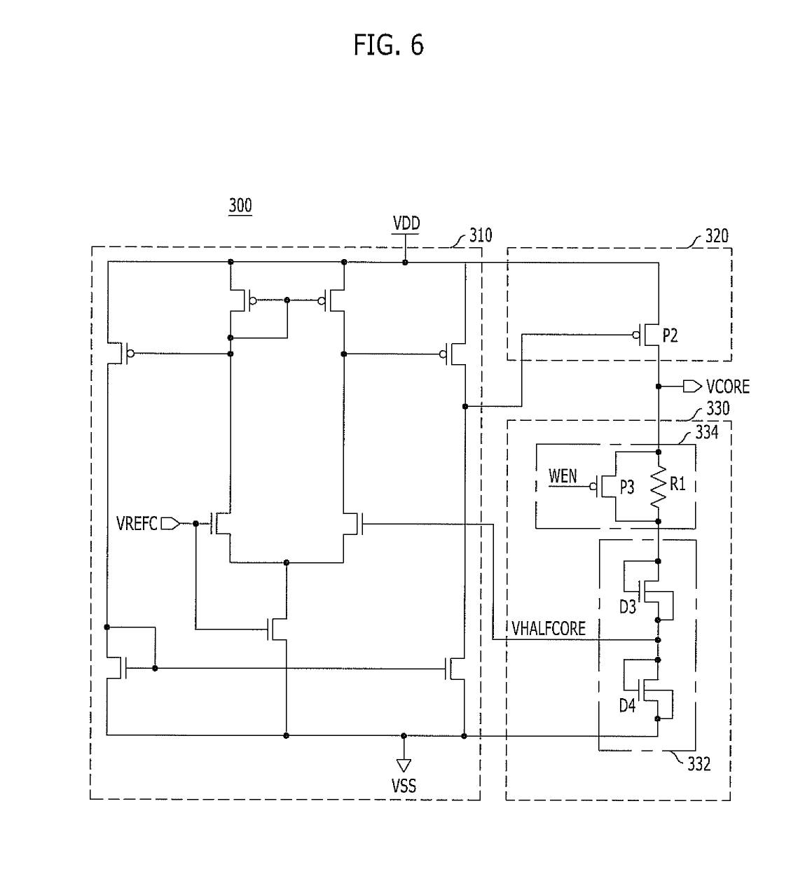

FIG. 5 is a block diagram illustrating a core voltage generator of a semiconductor integrated circuit in accordance with an embodiment of the present invention, and FIG. 6 is a circuit diagram illustrating the core voltage generator of FIG. 5.

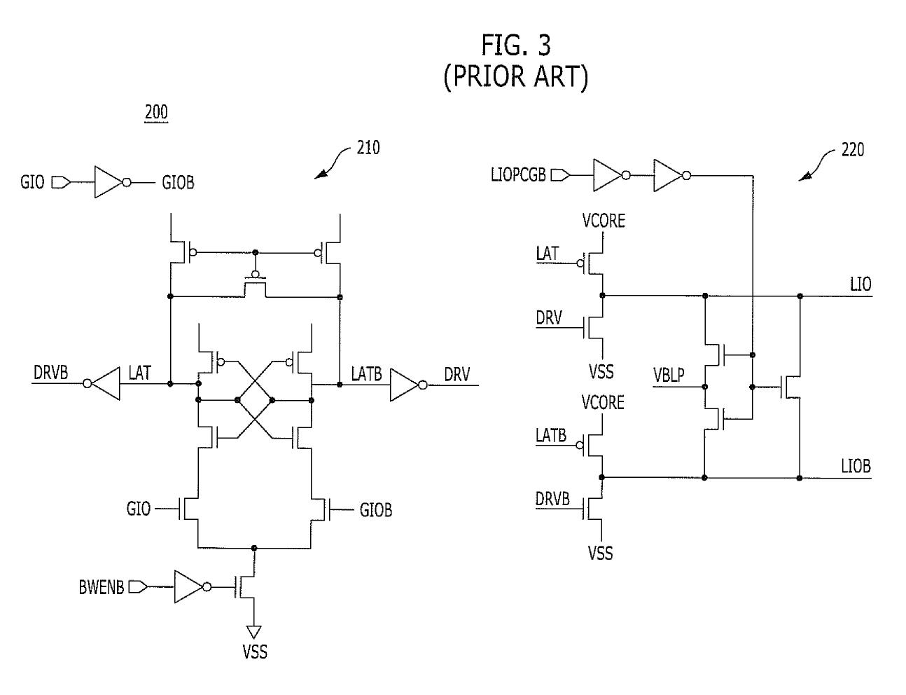

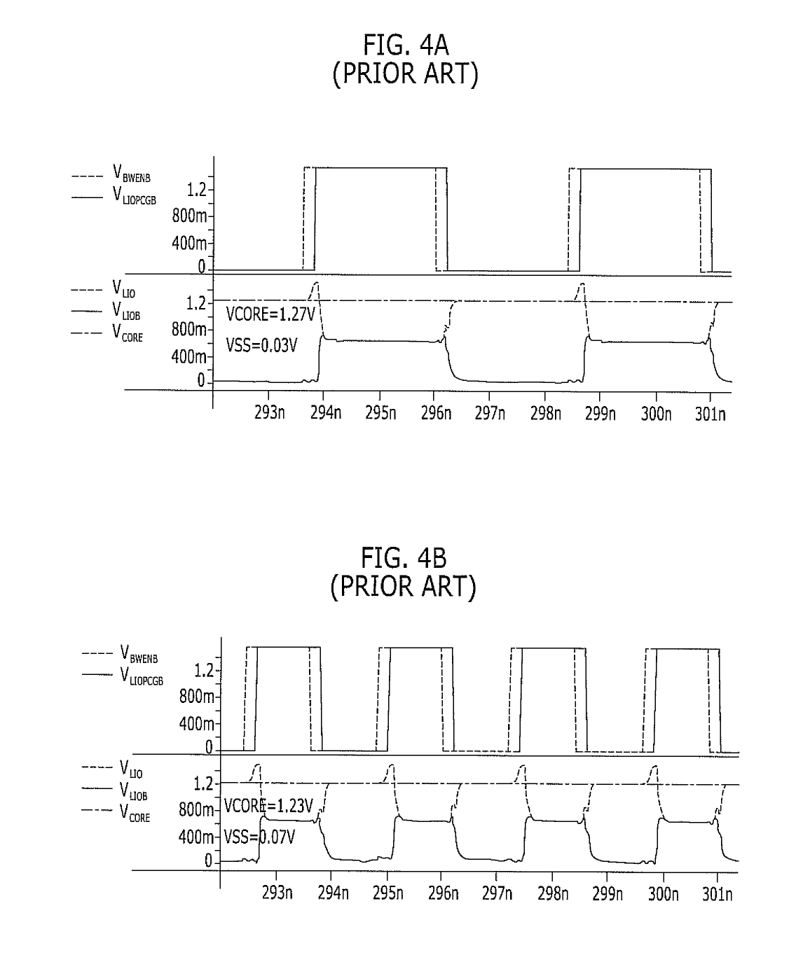

Referring to FIGS. 5 and 6, the core voltage generator 300 includes a comparison unit 310, a pull-up driving unit 320, and a feedback unit 330. The comparison unit 310 is configured to compare a reference voltage VREFC with a feedback voltage VHALFCORE. The pull-up driving unit 320 is configured to pull up a voltage of a core voltage (VCORE) terminal in response to an output signal of the comparison unit 310. The feedback unit 330 is coupled between the core voltage (VCORE) terminal and a ground voltage (VSS) terminal, and configured to divide a voltage of the core voltage (VCORE) terminal and output the feedback voltage VHALFCORE. Also, the feedback unit 330 is configured to adjust a division ratio in response to a control signal WEN. The control signal WEN is a signal derived from a write enable signal BWENB. The control signal WEN has a similar timing to the write enable signal BWENB and may be an inversion of the write enable signal BWENB (see FIG. 3). (Herein, the write enable signal BWENB is characterized, for example, such that it has a logic low level when it is said to be activated, and it has a logic high level when it is said to be deactivated.)

The comparison unit 310 is implemented with a current mirror differential amplifier.

The pull-up driving unit 320 may include a PMOS transistor P2 having a source coupled to a power supply voltage (VDD) terminal, a drain coupled to the core voltage (VCORE) terminal, and a gate receiving an output signal of the comparison unit 310.

The feedback unit 330 includes a division section 332 and a division ratio control section 334. The division section 332 is configured to divide a voltage applied between the core voltage (VCORE) terminal and the ground voltage (VSS) terminal according to a first division ratio which is previously set, and output the division voltage VHALFCORE to the comparison unit 310. The division ratio control section 334 is configured to change the division ratio of the division section 332 to a second division ratio in response to the control signal WEN. The division section 332 includes first and second diodes D3 and D4 coupled in series between the core voltage (VCORE) terminal and the ground voltage (VCORE) terminal. Further, the division section 332 may be configured to output the division voltage VHALFCORE, which has a voltage level that is approximately equal to half of the core voltage VCORE. The division ratio control section 334 may include an auxiliary resistor element R1 provided to add a certain resistance to the first diode D3, and a bypass element P3 configured to selectively bypass the auxiliary resistor element R1 in response to the control signal WEN. The bypass element P3 may be implemented with a PMOS transistor having a source coupled to the core voltage (VCORE) terminal, a drain coupled to an input terminal of the division section 332, and a gate receiving the control signal WEN. Although it is illustrated that the division section 332 is implemented with the first and second diodes D3 and D4 and the auxiliary resistor part R1 is implemented with a resistor, they are not limited thereto. The division section 332 and the auxiliary resistor element R1 may be implemented with any elements which can adjust the resistance. The elements of the division section 332 are ideally configured so that a voltage level of a node between the first and second diodes D3 and D4 is half of the voltage difference between the core voltage (VCORE) terminal and the ground voltage (VSS) terminal. Thus, the bypass element P3 is configured to bypass the auxiliary resistor element R1 to reflect the first division ratio in a normal mode in which the voltage level of the ground voltage VSS does not change. On the other hand, the auxiliary resistor element R1 is configured to increase the resistance in cooperation with the first diode D3 to reflect the second division ratio in an operation mode in which the voltage level of the ground voltage VSS changes. Therefore, the feedback unit 330 outputs a half core voltage VHALFCORE, which is a medium voltage between the core voltage VCORE and the ground voltage VSS, in the normal mode, and maintains the same half core voltage VHALFCORE in the operation mode. In other words, the feedback unit 330 outputs a constant half core voltage whether in the normal mode or in the operation mode.

The operation of the core voltage generator of the semiconductor integrated circuit in accordance with an exemplary embodiment of the present invention will be described below.

Specifically, the normal mode and the operation mode will be described, and the case in which the operation mode is a write operation mode will be exemplified.

First, the normal mode will be described.

Since the write enable signal BWENB is in a deactivated state in the normal mode, the control signal WEN is deactivated and thus applied to the feedback unit 330.

The feedback unit 330 applies the half core voltage VHALFCORE to the comparison unit 310. The half core voltage VHALFCORE corresponds to half the voltage of the core voltage terminal. More specifically, the bypass element P3 is turned on in response to the deactivated control signal WEN and bypasses the auxiliary resistor element R1. The division section 332 divides the voltage between the core voltage (VCORE) terminal and the ground voltage (VSS) terminal at the first ratio determined by the first and second diodes D3 and D4, and applies the half core voltage VHALFCORE to the comparison unit 310 as the division voltage.

The comparison unit 310 compares the half core voltage VHALFCORE applied from the feedback unit 330 with the reference voltage VREFC, and the pull-up driving unit 320 is enabled or disabled in response to the output signal of the comparison unit 310. When the determination result of the comparison unit 310 is that the half core voltage VHALFCORE is lower than the reference voltage VREFC, the pull-up driving unit 320 is enabled to drive the core voltage (VCORE) terminal to the power supply voltage VDD.

In this case, the voltage level of the core voltage (VCORE) terminal rises, and thus, the voltage level of the half core voltage VHALFCORE applied from the feedback unit 330 also rises. Subsequently, when the voltage level of the half core voltage VHALFCORE reaches the voltage level of the reference voltage VREFC, the comparison unit 310 detects this equilibrium point and disables the pull-up driving unit 320. Hence, the core voltage (VCORE) terminal is substantially maintained at a certain voltage level.

Next, the write operation mode will be described below with reference to FIG. 3 and FIG. 6.

The write enable signal BWENB is activated, and the latch unit 210 determines the voltage levels of the driving control signals LAT and LATB and DRV and DRVB in response to the data signals loaded on the global input/output lines GIO and GIOB. The output driving unit 220 pulls up the local input/output lines LIO and LIOB to the core voltage VCORE and pulls down the local input/output lines LIO and LIOB to the ground voltage VSS in response to the driving control signals LAT and LATB and DRV and DRVB.

As the write driver 200 is enabled, the core voltage VCORE generated by the core voltage generator 300 may be supplied to the local input/output lines LIO and LIOB, so that the voltage level of the core voltage (VCORE) terminal of the core voltage generator 300 drops. Therefore, the core voltage generator 300 performs the following operations in order to substantially maintain the core voltage (VCORE) terminal at a certain voltage level.

When the write enable signal BWENB is activated, the feedback unit 330 receives the activated control signal WEN. The feedback unit 330 divides the voltage difference between the core voltage (VCORE) terminal and the ground voltage (VSS) terminal according to the second division ratio, and feeds the half core voltage VHALFCORE to the comparison unit 310 as the division voltage. More specifically, the bypass element P3 is turned off in response to the control signal WEN which is activated in the write operation mode. Thus, the auxiliary resistor element R1 is bypassed. Consequently, the resistance across the division section 332 varies, and the second division ratio different from that in the normal mode is reflected. This is because the write driver 200 consumes a large amount of the operating current during the write operation mode, and thus, the ground voltage VSS used by the write driver 200 rises by a predetermined voltage level (current used×resistance of the voltage line). In particular, the voltage level of the ground voltage VSS rises more in the high frequency environment in which a large amount of the operating current is consumed. Because the ground voltage VSS is applied to the core voltage generator 300, it is desirable to compensate for the rising ground voltage VSS. In order to compensate for the rise in the voltage level of the ground voltage VSS, the division ratio is adjusted to the second division ratio.

Then, the comparison unit 310 compares the division voltage VHALFCORE outputted from the feedback unit 330 with the reference voltage VREFC, and outputs the comparison result signal to the pull-up driving unit 320. At this time, the comparison unit 310 detects that the division voltage VHALFCORE is lower than the reference voltage VREF, and outputs the output signal of a logic low level to the pull-up driving unit 320.

Accordingly, the pull-up driving unit 320 is turned on to drive the core voltage (VCORE) terminal to the power supply voltage VDD. Hence, the voltage level of the core voltage (VCORE) terminal rises and the division voltage VHALFCORE outputted from the division section 332 also rises.

Subsequently, when the division voltage VHALFCORE becomes equal to the reference voltage VREFC, the driving unit 320 is disabled in response to the output signal of the comparison unit 310.

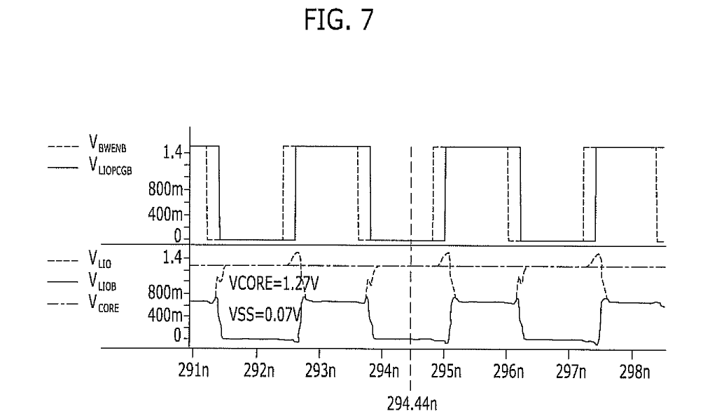

Through these operations, the voltage level of the core voltage (VCORE) terminal is constantly maintained, regardless of the normal mode and the write operation mode. As illustrated in FIG. 7, the voltage level of the ground voltage VSS may actually rise to 0.07 V as the write driver 200 is enabled. Thus, the division ratio control section 334 compensates for the rising voltage level of the ground voltage VSS. Consequently, even though the operation mode changes from the normal mode to the write operation mode, the voltage level of the core voltage (VCORE) terminal can be constantly maintained at 1.27 V.

In accordance with the exemplary embodiments of the present invention, even though the write driver 200 is enabled and thus the voltage level of the ground voltage VSS rises, the voltage level of the ground voltage (VCORE) terminal is constantly maintained, thereby substantially preventing malfunction during the write operation.

Furthermore, it is possible to substantially prevent the case in which the voltage level of the core voltage VCORE is incorrectly adjusted due to the increase in the voltage level of the ground voltage VSS during the write operation. In particular, the effect is prominently exhibited in the high frequency environment. Thus, the operational reliability and stability of the semiconductor integrated circuit in accordance with the exemplary embodiments of the present invention may be enhanced.

While the present invention has been described with respect to the specific embodiments, it will be apparent to those skilled in the art that various changes and modifications may be made without departing from the spirit and scope of the invention as defined in the following claims.

Although it has been described above that the internal voltage generator generates the voltage to be supplied to the write driver, it is not limited thereto. For example, the internal voltage generator in accordance with the exemplary embodiments of the present invention may also be applied to a variety of peripheral circuits, such as a delay locked loop (DLL) and a phase locked loop (PLL), which may consume a large amount of an operating current.

What is claimed is:

1. An internal voltage generator of a semiconductor integrated circuit, comprising:
a comparison unit configured to compare a reference voltage with a feedback voltage;
a driving unit configured to drive an internal voltage terminal in response to an output signal of the comparison unit; and
a feedback unit configured to divide a voltage of the internal voltage terminal according to a division ratio adjustable in response to a control signal and output a division voltage as the feedback voltage.

2. The internal voltage generator of claim 1, wherein the feedback unit is coupled between the internal voltage terminal and a ground voltage terminal and the division ratio is predetermined.

3. The internal voltage generator of claim 1, wherein the feedback unit comprises:
a division section configured to divide a voltage applied between the internal voltage terminal and the ground voltage terminal according to a first division ratio, and output the division voltage as the feedback voltage; and
a division ratio control section configured to change the division ratio of the division section to a second division ratio in response to the control signal.

4. The internal voltage generator of claim 3, wherein the division section comprises first and second resistances coupled in series between an internal control terminal and the ground voltage terminal.

5. The internal voltage generator of claim 4, wherein the division ratio control section comprises an auxiliary resistor coupled in series between the internal voltage terminal and the internal control terminal and configured to add a certain resistance between the internal voltage terminal and the ground voltage terminal, and a bypass element configured to selectively bypass the auxiliary resistor in response to the control signal.

6. The internal voltage generator of claim 1, wherein the control signal comprises a write enable signal.

7. The internal voltage generator of claim 1, wherein the control signal is an inversion of the write enable signal.

8. The internal voltage generator of claim 3, wherein the feedback unit divides the voltage applied between the internal voltage terminal and the ground voltage terminal according to the first division ratio and outputs the division voltage as the feedback voltage, when the semiconductor integrated circuit is in a normal mode.

9. The internal voltage generator of claim 3, wherein the feedback unit divides the voltage applied between the internal voltage terminal and the ground voltage terminal according to the second division ratio and outputs the division voltage as the feedback voltage, when the semiconductor integrated circuit is in an operation mode.

10. The internal voltage generator of claim 4, wherein the first and second resistances are configured to divide the voltage applied between the internal voltage terminal and the ground voltage terminal according to the first division ratio, which is previously set, and output the division voltage as the feedback voltage.

11. The internal voltage generator of claim 3, wherein the bypass element is enabled so that only the first and second resistances divide the voltage applied between the internal voltage terminal and the ground voltage terminal according to the first division ratio, and output the division voltage as the feedback voltage, when the semiconductor integrated circuit is in a normal mode.

12. The internal voltage generator of claim 4, wherein the bypass element is disabled so that the first and second resistances and the auxiliary resistor divide the voltage applied between the internal voltage terminal and the ground voltage terminal according to a second division ratio, which is previously set, and outputs the division voltage as the feedback voltage, when the semiconductor integrated circuit is in an operation mode.

13. The internal voltage generator of claim 9, wherein the first and second resistances are configured so that a voltage level of a node between the first and second resistances is about half of the voltage difference between the internal voltage terminal and the ground voltage terminal.

14. The internal voltage generator of claim 1, wherein the comparison unit comprises a current mirror differential amplifier.

15. The internal voltage generator of claim 1, wherein the driving unit comprises a PMOS transistor having a source coupled to a power supply voltage terminal, a drain coupled to the internal voltage terminal, and a gate receiving an output signal of the comparison unit.
